(19) United States
(12) Patent Application Publication
(10) Pub. No.: US 2025/0264133 A1
(43) Pub. Date: Aug. 21, 2025

(54) BEARING RING

(71) Applicant: AKTIEBOLAGET SKF, GOTEBORG (SE)

(72) Inventors: Felix STEINWENDER, Steyr (AT); Karl PREIS, Traun (AT)

(21) Appl. No.: 19/052,559

(22) Filed: Feb. 13, 2025

(30) Foreign Application Priority Data
Feb. 20, 2024 (DE) 102024201547.4
Jan. 24, 2025 (DE) 102025102603.3

(51) Int. Cl. F16C 33/58

(52) U.S. Cl. CPC F16C 33/583

(57) ABSTRACT

A bearing ring includes a first ring portion, a second ring portion and a third ring portion, and the second ring portion is radially sandwiched between the first ring portion and the third ring portion. At least a portion of the first ring portion forms a running surface for a rolling-element. The second ring portion is disposed on the first ring portion, the third ring portion is disposed on the second ring portion, and the third ring portion comprises an axially split ring or a radially split ring.

### CROSS-REFERENCE

This application claims priority to German patent application no. 10 2024 201 547.4 filed on Feb. 20, 2024, and to German patent application no. 10 2025 102 603.3, filed on Jan. 24, 2025, the contents of which are fully incorporated herein by reference.

### TECHNOLOGICAL FIELD

The present disclosure is directed to a bearing ring having a sandwich structure and to a method of making such a bearing ring.

### BACKGROUND

In roll bearings or slide bearings, it may be necessary to optimize one or more bearing components with regard to electrical insulation, weight or the like. For electrical insulation, it is known, for example, to produce one of the bearing components, for example a ring or a rolling body, from an insulating material. This can, however, have the disadvantage that other requirements placed on the corresponding bearing component are at least not sufficiently met, if at all, for example load-bearing capacity, etc. The situation is similar for weight. If a bearing component is produced from a more lightweight material, this can adversely affect load-bearing capacity. As an alternative, it is possible to apply coatings to the outer surface of a bearing ring. This too can, however, in turn have an adverse effect on load-bearing capacity and/or the coating, which can serve as electrical insulation for example, is damaged by the typical load on a bearing ring and is then unable to continue to fulfil its function.

CN 1 16 792 412 A discloses a composite ceramic bearing having a metallic outer ring, a metallic inner ring and a rolling body, wherein a first annular groove is formed in the inner surface of the metallic outer ring, a first rubber layer is disposed in the first annular groove, and a first ceramic layer is disposed on the surface of the first rubber layer. A second annular groove is formed in the outer surface of the metallic inner ring, with a second rubber layer disposed in the second annular groove and a second ceramic layer disposed on the surface of the second rubber layer. The first ceramic layer and the second ceramic layer form a ceramic raceway to support the rolling body.

EP 2 957 784 A1 discloses a bearing having a lining layer that includes an alloy having a defined shape and a beveled section, and also a coating layer of a resin on an inner circumferential surface of the lining layer, where the inner circumferential surface slides relative to a fitting shaft and covers at least a section of the beveled section.

### SUMMARY

It is therefore an aspect of the present disclosure to provide a bearing ring having sufficient load-bearing capacity, while simultaneously being able to reliably and sustainably provide further functionalities.

A bearing ring typically has a running surface and an opposite surface opposite to the running surface. The running surface may be either the inner or outer surface, depending on whether the bearing ring is an outer ring or an inner ring.

The bearing ring disclosed herein has a sandwich structure composed of at least three layers. The first layer at least partly forms the running surface, the second layer is disposed on the first layer as an interlayer, and the third layer is at least partly disposed on the interlayer. This sandwich structure makes it possible to use different materials for the various layers and in this way both to meet the requirements placed on the running surface and the opposite surface to the running surface, for example in relation to load-bearing capacity, by virtue of the first and third layers, and to add further functionalities to the bearing ring by virtue of the interlayer.

In order to enable different geometries of the first layer forming the running surface and of the second interlayer, the third layer takes the form of a split ring. This has the advantage that this layer can be pushed onto the second layer after production and assembly of the first and second layers. In this way, it is possible, for example, for the first layer, i.e. the running surface or else running ring, to be formed in a very robust manner, since the split ring can be arranged around or can be pushed onto this running surface, i.e. the first layer and the second layer. The geometry of the split ring may thus adapt completely to the geometry of the first layer and of the interlayer and does not constitute a restriction of these geometries. In particular, the first layer, i.e. the running surface or running ring, takes the form here of an unsplit ring, i.e. in one-piece form. The interlayer is likewise arranged as an unsplit layer on this unsplit ring. This means that only the third layer takes the form of a split ring. The bearing ring thus consists of a combination of unsplit (first layer and interlayer) and split rings or layers (third layer).

It should be noted here that the first layer, i.e. the layer that forms the running surface, may be the innermost or outermost layer. In other words, the bearing ring may be an inner ring or an outer ring. The third layer, i.e. the split ring, is thus accordingly either arranged around the outer circumference or in the inner circumference of the bearing ring. What is therefore meant by “pushing on” in this connection is pushing into the inner circumference or pushing onto the outer circumference of the bearing ring.

The split ring, i.e. the third layer, may either be in radially or axially split form. In both cases, the split ring may be simply arranged around the first layer and the interlayer. As will be elucidated in detail further down, the split ring may either be produced in one-piece form and then split, for example by breaking, or may be produced as two separate parts.

In order to ensure good load-bearing capacity of the running surface that comes into contact with rolling bodies or a counterpart running surface, and also of the opposite surface to the running surface, which comes into contact with a housing, for example, the running surface may be produced from a first material and the opposite surface to the running surface from a third material. The first and the third material may be identical or different. In order, however, to then at the same time achieve further functionalities which cannot be provided by the first and the third material, the interlayer consists of a second material, which is arranged at least partially between the first and the third material. The second material is different from the first and the third material. In this way, the interlayer makes it possible to easily provide a further functionality or multiple further functionalities without adversely affecting the functionalities of the bearing ring per se that are provided by the first and the third material. For example, the interlayer may serve for damping, electrical insulation or to save on bearing steel.

The interlayer makes it possible, as described, to give the bearing ring a further functionality. At the same time, however, the bearing ring per se is not modified. This means that both the outer dimensions and the handling of the bearing ring correspond to those of a conventional bearing ring. It can therefore easily be used in existing systems or bearings or else exchanged for bearing rings used there. Furthermore, the proposed bearing ring can provide reduced processing outlay and/or a reduced energy requirement compared to existing bearing types.

According to one embodiment, the bearing ring has a radially inner surface and a radially outer surface and a first and a second end face, wherein the interlayer extends from the first end face to the second end face (wherein the running surface is the radially inner or the radially outer surface). The interlayer extends in particular all around the circumference, preferably continuously all around the circumference.

This means that the interlayer can extend completely continuously and thus provide the functionality provided by the third material over the entire bearing ring. This is advantageous, for example, in the case where the third material provides damping or in the case of electrical insulation.

The interlayer may also extend at an angle and, in cross section, may reach for example from the first to the second end face and additionally extend up to the inner and/or the outer lateral surface. As an alternative, the interlayer may also extend from the inner to the outer lateral surface and additionally up to the first and/or second end face. This can be advantageous in particular in the case of angular contact balls or angular contact roller bearings, the surfaces of which are subject to angular loading, and as a result so is the interlayer.

According to a further embodiment, as already mentioned above, the first material and the third material may be identical. For example, the first and the third material may be hardened, e.g. hardened steel, in order to be able to withstand the stresses to which it is subject as a result of contact with a housing, rolling bodies or a counterpart running surface.

The first material and/or the third material may preferably comprise metal (e.g. steel, non-ferrous metals such as aluminum, etc.), ceramic, and/or composite materials, in particular non-polymer-based composite materials. These materials are particularly durable in order to withstand the aforementioned loads exerted on the running surface and the opposite surface to the running surface.

In particular, the material of the third layer, i.e. the split ring, is suitable for splitting, for example by breaking. In this case, the ring is produced in one-piece form and then is broken radially or axially by a tool. This has the advantage that the two halves of the ring can be finish machined prior to division and, after division, can simply be pushed onto the first and second layers. If the split ring is manufactured from two parts, this has the advantage, for example, that the two parts can be manufactured from inexpensive sheet metal parts. The manufacture can be less precise, and the two parts may subsequently be finish processed, for example ground.

According to a further embodiment, the second material of the interlayer comprises a material that fulfils an insulating, damping and/or weight-reducing function. For example, the second material may be a plastic, in particular a polymer, thermoset, thermoplastic, a plastics composite, and/or a ceramic plastic. As an alternative, the second material may also be a metal, such as aluminum, e.g. aluminum foam. The second material may additionally include paper, glass and/or semiconductors or other materials that fulfil corresponding desired functions.

In order to increase the load-bearing capacity of the second material, it may be fiber-reinforced, for example by carbon fibers. The second material may alternatively or additionally also be given a further additional functionality by providing the second material with filler materials. These filler materials may, for example, be materials which can have a damping effect on the bearing ring, i.e. reduce noises and/or vibrations. In this respect, examples of materials which can be used are thermosets, thermoplastics or rubber variants, or generally polymers. The mechanical properties can be established depending on the type and amount of the filler material. For example, if the interlayer is to be optimized in terms of electrical insulation, it can have a different level of filler material than an interlayer which is to be optimized only for the purpose of damping vibrations, for example. This means that, in one embodiment, the properties of the interlayer can be adapted via the amount of filler material.

Such filler materials also make it possible to prevent chatter and resulting chatter marks and/or frictional corrosion. Furthermore, such filler materials also make it possible to obtain electrical insulation, in which case it is possible for the filler materials to contain, for example, ceramics such as aluminum oxide, silicon carbide, rutile, zinc oxide, zirconium oxide, silicon nitride, glass, etc. In particular, it is possible here to use materials which can increase the electrical impedance of the interlayer and hence prevent an electrical discharge.

In general, the filler materials may provide mechanical and/or functional properties. These properties may, for example, be thermoelectric properties and/or thermophysical properties, elevated and/or reduced mechanical stress, identification of mechanical strain (via piezo elements, change in color, etc.), tactile properties, optical properties, olfactory properties, reduced and/or elevated surface tension, wettability of the interlayer (e.g. adding lubricants, etc.), corrosion properties, or a combination of the properties listed.

Expressed in general terms, the interlayer, in particular owing to the filler materials it contains, may have properties which ensure that the interlayer reacts to temperature, electrical voltage, mechanical stress and/or mechanical strain. As already mentioned above, these properties may be influenced both by the type of filler materials and by the amount of the filler materials.

The fibers and/or filler materials may be of different size and shape (e.g. spheres or rolls, or any other shape and size, for example fragment shapes). They may range from a powder form measured in micrometers to individual particles measured in mm. The fibers and/or filler materials may also have different aspect ratios (e.g. from spheres through to long fibers).

The interlayer may have grooves, which are designed to receive elements, in regions which are free of the first and/or the third layer. The regions of the interlayer are regions of the interlayer that are accessible from the outside. Elements can engage or be snap-fitted into the grooves provided in these exposed regions, these elements being seals, for example, which can be used to seal off the bearing ring with respect to other surfaces. The elements may also be brushes, in particular earthing brushes, in order to dissipate electrical charge from the bearing ring. The interlayer may also have multiple grooves on each exposed side, so that multiple elements can be received on each side.

In a further embodiment, at least one additional element is embedded into the interlayer. The at least one additional element may be an electronic device, a lubricant and/or a lubricant reservoir. The at least one additional element may be embedded in the interlayer, for example in openings or grooves formed therein, completely, i.e. without contact with the first or the third layer. This has the advantage that, for example in the case of electronic devices, these are insulated in the interlayer and cannot be exposed to a flow of current or an electrical charge through the first or the third layer. As an alternative, the at least one additional element may be embedded in contact with the first and/or the third layer. This may in turn have the advantage that, in the case of electronic devices, for example if they are sensors, they can make measurements directly on these layers via contact with the first and/or the third layer. If the additional element is lubricant or a lubricant reservoir, the interlayer may preferably have lubricant outlets, e.g. grooves, leading out of the additional elements. A combination of different additional elements may also be embedded in the interlayer.

Electronic devices as additional element may be sensors, chips, antennas and/or wires, for example. For example, the at least one electronic device may be designed to process signals and may have appropriate elements for the purpose, in particular chips, microprocessors or the like. Similarly, elements that implement an antenna for signal transmission may be embedded in the interlayer as electronic device. In an illustrative embodiment, the interlayer may have a sensor and an antenna, so that the interlayer can firstly record parameters of the bearing ring or of the bearing in which the bearing ring is installed, and can also directly transmit these parameters to further devices via the antenna. Optionally, the interlayer may additionally have a signal processing unit (e.g. a microprocessor), so that the recorded parameters can be at least pre-processed directly in the interlayer.

These electronic devices can therefore be easily integrated directly in the bearing ring. It has to date been necessary to fasten sensors to the bearing ring externally for this purpose, but these sensors could then be externally damaged. Another alternative used to date was sensor rolling bodies, in the case of which the sensor system is disposed in the rolling body, for example in the bore of a sensor roller. However, the solution proposed here, which is to integrate sensors directly in the bearing ring, is easier to implement than such sensor rollers and also has the advantage that data or measurements can be acquired or taken directly on the bearing ring. It is thus not necessary for a sensor rolling body to take measurements and then for this information to be transferred to a bearing ring in order to obtain information about the bearing ring.

It should be noted that one or more sensors may be embedded in the interlayer. A combination of various sensors may also be embedded in the interlayer.

For example, the interlayer may contain thin layers of insulating, semiconducting or electrically conductive material, which form a sensor on the basis of their arrangement in relation to one another. For example, a sensor may be formed via a change in the electrical resistance or owing to piezoelectric or semiconducting properties of the interlayer or of the materials present in the interlayer. Such sensors include, for example, strain gauges, temperature sensors, acceleration sensors, etc. It is also possible, for example, to integrate glass fibers in the interlayer, and these glass fibers can then be used to infer, for example, a mechanical load via the changes in the optical properties. Such glass fibers can also be used as signal transmission elements.

As an alternative, the interlayer itself may also serve as a sensor, for example as a varistor, PTC thermistor or the like. In this case, the interlayer can be formed from an appropriate material, for example a polycrystalline ceramic which is semi-conductive in particular. For example, an electrical capacity or an electrical resistance of the interlayer may be indicative of parameters of the bearing ring, and the interlayer can therefore be used directly as a sensor.

In order to improve the bonding and durability between the first layer and second layer or the second layer and third layer, the first layer and/or the second layer may have a structured surface. The structured surface may have depressions and elevations, may be roughened by laser treatment or sandblasting, or may have a structured surface by virtue of any other processing operation, e.g. rotary fluting, knurling or the like. In each case, the structured surface may enable better adhesion of the second layer, since this cannot slip off the structured surface, but is held in place by static friction.

In addition, the surfaces of the respective layers, especially of the first and third layers, may be subjected to a pretreatment in order to ensure reliable bonding of the different layers to one another. Such a pretreatment may serve as surface preparation or substrate preparation for improved bonding of the individual layers. Such a pretreatment may include, for example, cleaning, sandblasting, lathing, knurling, etching, plasma activation, applying a chemical substrate (e.g. phosphating). The pretreatment, for example, roughens the respective surface (for example in order to obtain the above-described structured surface), in order that the layer applied or disposed thereon has better adhesion.

In a further embodiment, one or more openings, i.e. holes, that extend radially and/or axially, may be provided in the first, the second and/or the third layer. These openings may be provided either around the circumference (as radial opening) or on one of the two end faces or both of them (axial opening). If there are one or more openings in the first and/or the third layer, they may go from the outside of the bearing ring all the way through the first and/or the third layer. These openings may serve, for example, to enable contact with the interlayer, for example contact with an electronic device embedded therein, or may serve to inject the material of the interlayer between the first and third layers. In the latter case, it is also possible to blow out air through the openings, especially in order to create space for the material of the interlayer.

One or more openings in the interlayer may in particular be used for access to the embedded electronic device, for example to insert a wire or an optical fiber and connect the electronic device. In this case, the openings are preferably provided on an end face of the bearing ring. They may go all the way through the interlayer in axial direction, but may also go only part of the way through the interlayer, in particular from the outside to the at least one electronic device.

Furthermore, the one or more openings may serve as rotation safeguard for the bearing ring. The one or more openings may interact with an element on a housing or a shaft or some other component on which the bearing is mounted. This also makes it possible to ensure that a sensor wire, as mentioned above, is not sheared off during operation.

In a further aspect, a process for producing a bearing ring as described above is proposed. In the process, first of all, the first layer is provided as raceway ring. The first layer may especially have sufficient thickness to offer sufficient stability for the running surface of the raceway ring.

Subsequently, the interlayer is applied on the first layer. This can be done, for example, by overmolding of the first layer or injection molding onto the first layer. The second layer or interlayer may also be applied to the first layer via a 3D printing method, by coating methods, by brushing or other application methods.

Finally, the third layer is pushed onto the second layer or the combination of first layer and second layer as a split ring. Since the split ring is pushed on from two sides, it can embrace the combination of first and second layers such that the geometry of the raceway ring in particular may be varied and is not restricted, as would be the case for a one-piece ring as the third layer.

As already described above, the split ring may be produced as two separate parts or may be produced as a one-piece ring and then split.

The first layer that provides the running surface may especially take the form of an inner raceway ring, and the third layer, i.e. the split ring, may especially take the form of an outer ring, between which the interlayer is disposed. However, it is also possible to form the first layer as an outer ring with running surface and third layer as an inner ring.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE DRAWINGS

The invention will be described in detail hereinafter with reference to working examples shown in the drawings. The working examples and the combinations shown in the working examples are purely illustrative and are not intended to restrict the scope of protection of the invention. The latter is defined solely by the appended claims.

FIG. 1 is a schematic perspective view, partly in section, of a bearing ring according to a first embodiment of the present disclosure.

FIG. 2 is a schematic sectional view of the bearing ring of FIG. 1.

FIG. 3 is a schematic perspective view of a bearing ring according to a second embodiment of the disclosure.

FIG. 4 is a schematic perspective view of a bearing ring according to a third embodiment of the disclosure.

FIG. 5 is a schematic perspective view of a bearing ring according to a fourth embodiment of the disclosure.

### DETAILED DESCRIPTION

Identical or functionally identical elements are identified by the same reference numerals hereinafter.

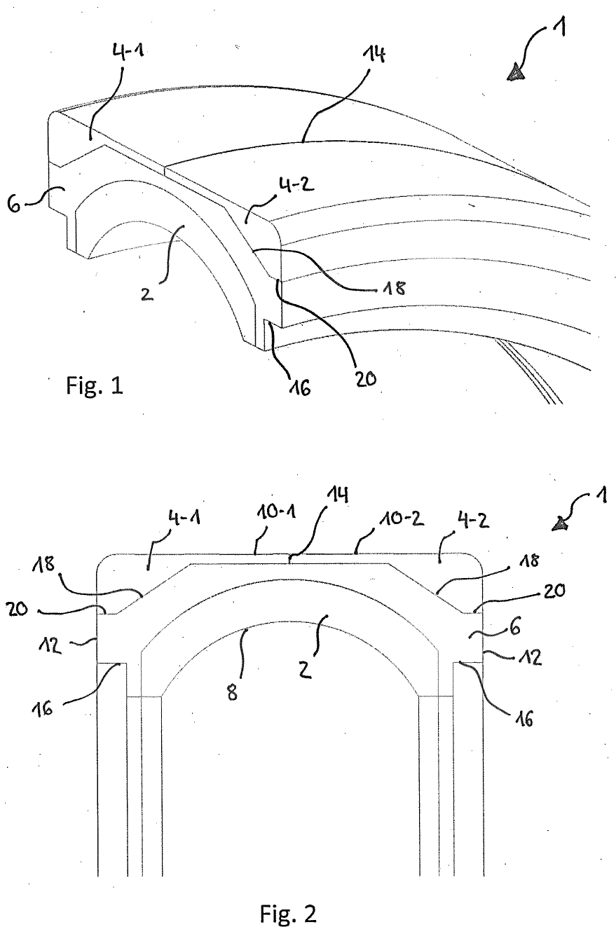

FIGS. 1 and 2 show a bearing ring 1. Although an outer ball bearing ring is shown here, the bearing ring 1 may generally be used in a rolling-element bearing, for example a ball bearing or a roller bearing, or in a slide bearing.

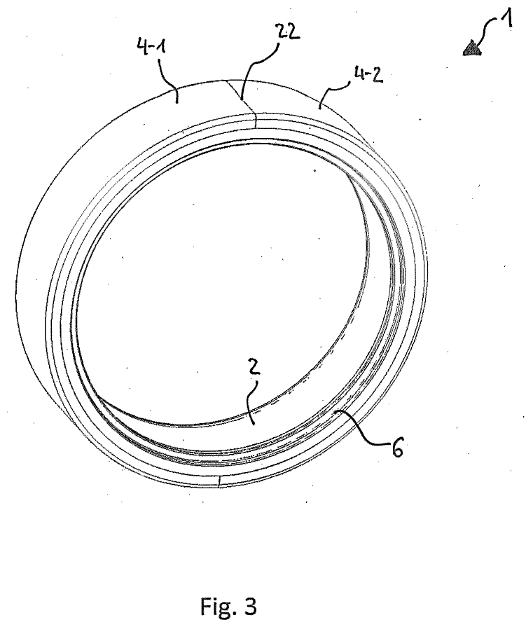

The bearing ring 1 is formed in a sandwich structure with three layers 2, 6, 4-1, 4-2. The first layer 2 at least partly forms a running surface 8. The second layer 6 is an interlayer disposed on the first layer 2. The third layer 4-1, 4-2 is at least partly disposed on the interlayer 6 and forms the opposite surface 10-1, 10-2 to the running surface. The first, second and third layers may sometimes be referred to hereinafter as first, second and third “ring portions.” The third layer 4-1, 4-2 takes the form of a split ring and may, as shown in FIGS. 1 and 2, be split axially into two parts 4-1, 4-2, or may, as shown in FIG. 3, be split radially into two parts 4-1, 4-2. In particular, only the third layer 4-1, 4-2 takes the form of a split ring, whereas no division is provided in the case of layers 2, 6.

In the embodiment shown in FIG. 1, the bearing ring 1 is illustrated as an outer ring, with the running surface being formed by the radially inner surface 8 and the opposite surface to the running surface being formed by the radially outer surface 10-1, 10-2. However, it should be noted that the radially outer surface may also be the running surface, and the radially inner surface may also be the opposite surface to the running surface. In this case, the inner layer would take the form of a split ring.

The bearing ring 1 is described hereinafter in the configuration of an outer ring, though all configurations are applicable to all above-mentioned alternative configurations. It should be noted here that, in the case of a split inner ring, this should preferably be split axially, as shown in FIGS. 1 and 2.

In order to provide a high load-bearing capacity of the running surface and of the opposite surface to the running surface, the first and the third layer 2, 4-1, 4-2 are formed of materials, for example hardened steel, that are capable of providing both a stable and durable running surface that can withstand contact with rolling bodies or a counterpart running surface, and a surface which is opposite the running surface and is able to bear high loads, for example those produced by contact with a housing. The interlayer 6, by contrast, may be formed of materials such as polymer, thermoset or other plastics, which provide a different functionality than that of the first and the third layer 2, 4-1, 4-2. For example, the material of the interlayer 6 may serve to damp vibrations, to electrically insulate the first and the third layer 2, 4-1, 4-2, or to reduce the weight of the overall bearing ring 1. Other functionalities may also be provided by this interlayer 6.

The interlayer 6 may be configured in different radial and circumferential dimensions and shapes. This may depend on the desired functionality. If the intention is for the interlayer 6 to provide weight reduction, the interlayer 6 overall should take up a greater volume of the overall bearing ring 1. If the intention is only that the interlayer 6 prevent a flow of electrical current through the bearing ring 1, a thin interlayer 6 may be adequate for this function. This applies in particular to DC voltages, for which a relatively thin insulating layer having a desired dielectric strength is sufficient. For high-frequency AC currents, an electrical capacitance which is as small as possible to achieve the desired high impedances is required. In this case, the interlayer 6 should therefore be thicker. Furthermore, the geometry of the sandwich structure should be matched to the connection dimensions of the bearing seat, in order to avoid short circuits and/or flashovers through the air.

The interlayer 6 may be made of filled polymers (e.g. filled with ceramics such as aluminum oxide, silicon carbide, rutile, zinc oxide, zirconium oxide, glass and silicon nitride, etc.) or (fiber- or particle-) reinforced polymers, of mica paper, phenol resin-impregnated paper or any other filler materials. Such an interlayer 6 is of particularly good suitability for preventing an electrical discharge as a result of a significant rise in electrical impedance. Owing to this interlayer structure 6, very low capacitances can be achieved with very high impedance values.

In one configuration, the interlayer 6 may have grooves 16, as shown in FIGS. 1 and 2. Additional elements, which either constitute the functionality of the interlayer 6 or enable an additional functionality, may engage in these grooves 16. For example, these additional elements may be earthing (grounding) brushes, which can come into contact with a further element of a bearing. As an alternative, these additional elements may be seals or the like. They may make contact with elements surrounding the bearing, in order to seal off the bearing.

In a further embodiment, it is possible to embed sensors into the interlayer 6. For this purpose, sensors, monitoring systems or the like may be embedded in the interlayer 6. The sensors may, for example, be thermocouples, vibration sensors, load sensors. Embedding in the interlayer 6 makes it possible to mount the sensors close to the running surfaces, in order to improve the accuracy of the data when information is being recorded, for example from rolling bodies which roll on the running surface 8. Such sensors make it possible, for example, to detect vibrations in the bearing.

The sensors can be embedded in the interlayer either directly, without contact with the first or the third layer 2, 4-1, 4-2, or they may be in contact with one of the layers 2, 4-1, 4-2. For example, the sensors may be placed onto the layer 2 and then overmolded with the interlayer 6.

In a similar way to the embedding of the sensors, it is also possible to embed lubrication in the interlayer 6. For example, one or more lubricant reservoirs or depots may be embedded in the interlayer 6. During operation, lubricant can be dispensed from these lubricant depots. As an alternative, one or more grooves or cutouts which make it possible for oil to flow through may also be provided in the interlayer 6. This means it is not necessary to provide further lubricant grooves or the like.

As shown in FIGS. 1 and 2, the interlayer 6 may have a geometry with a bevel 18 running toward the two end faces 12 and a subsequent step 20. Such a geometry of the interlayer 6 and the round geometry of the inner layer 2 is possible since the split ring 4-1, 4-2 is pushed over layers 2 and 6 from the two end faces 12. In this way, the raceway ring 2 may have a thicker configuration since the split ring 4-1, 4-2 is not pushed around the raceway ring 2 as a whole, but can embrace the raceway ring 2 from the two end faces 12. The interlayer 6 may either be applied to the raceway ring 2 beforehand or may be injection-molded subsequently between the raceway ring 2 and the split ring 4-1, 4-2.

As already elucidated, the split ring 4-1, 4-2 may have an axial split 14 (FIGS. 1 and 2) or a radial split 22 (FIG. 3). In both cases, the raceway ring 2 may have any geometries, since the split ring 4-1, 4-2 can be pushed onto it from two sides.

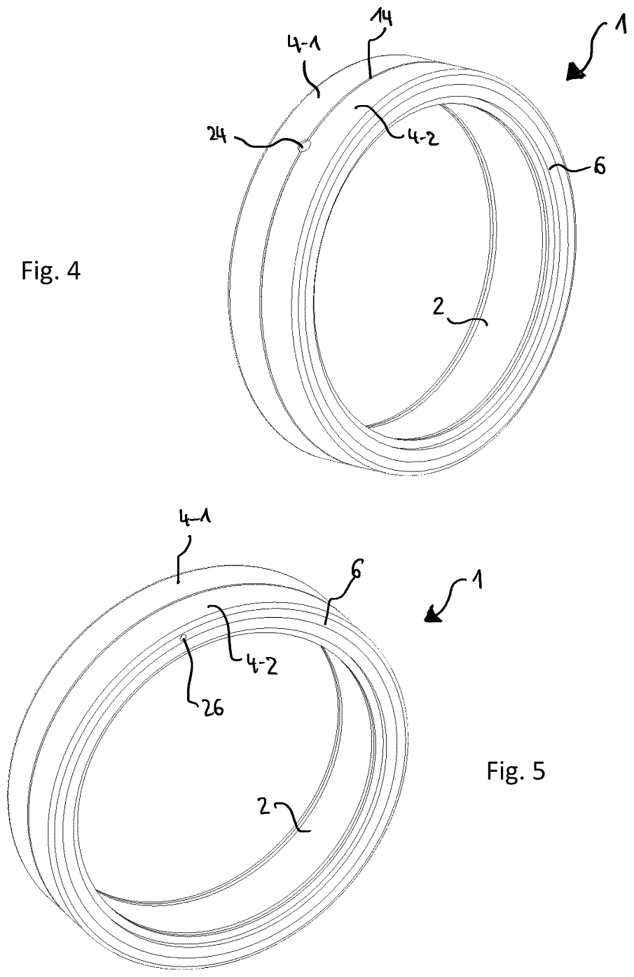

As shown in FIG. 4, the bearing ring 1 may have a radial opening 24 in the third layer 4-1, 4-2. As an alternative, the opening 24 may also be provided in the first layer 2 or go from the first layer 2 or the third layer 4-1, 4-2 through the interlayer 6. Although only one opening 24 is shown, it is also possible to provide multiple radial openings 24. These may go completely through the first and/or the third layer 2, 4-1, 4-2 from the outside of the bearing ring 1. The openings 24 may serve, for example, to enable contact or access to the interlayer 6. If the one or more openings 24 are provided in the third layer 4-1, 4-2, these may especially be provided in the region of the split between the first part 4-1 and the second part 4-2 of the third layer.

Furthermore, one or more axial openings 26 in the end faces 12 may be provided in one or more of the layers 2, 4-1, 4-2, 6. Such an axial opening 26 is shown by way of example in FIG. 5. In the embodiment shown, the opening 26 is disposed in the interlayer 6; it is also possible to provide an axial opening in one of the other layers 2, 4-1, 4-2. Such an axial opening 26 may be used, for example, to have access to an electronic device embedded in the interlayer, for example to feed in or out a wire coupled to such an electronic device.

Although the bearing ring 1 is shown with an axially split layer 4-1, 4-2 in FIGS. 4 and 5, the described openings 24, 26 may likewise be used with a radially split layer 4-1, 4-2, as shown in FIG. 3. It should therefore be noted that the openings 24, 26 shown in FIGS. 4 and 5 may be combined with one another and with the rest of the configurations of the bearing ring 1 as desired, as illustrated in FIGS. 1 to 3.

In summary, the bearing ring described here makes it possible to provide the customary functionality of a bearing ring, including the load-bearing capacity of the inner and the outer surfaces, and additionally a further functionality. At the same time, however, the outer dimensions of the bearing ring are not modified, and therefore it can replace conventional bearing rings of the same dimensions. In addition, the geometry of the bearing ring, especially the geometry of the running surface and the corresponding layer, are not limited by the split third layer or ring.

### REFERENCE NUMBER LIST

1 bearing ring
2 first layer/raceway ring
4-1, 4-2 third layer/split ring
6 interlayer
8 running surface/inner lateral surface
10-1, 10-2 outer lateral surface
12 end faces
14 axial split
16 groove
18 bevel
20 step
22 radial split
24 radial opening
26 axial opening

What is claimed is:

1. A bearing ring comprising:
a first ring portion, a second ring portion and a third ring portion,
wherein the second ring portion is radially sandwiched between the first ring portion and the third ring portion,
wherein at least a portion of the first ring portion forms a running surface for a rolling-element,
wherein the second ring portion is disposed on the first ring portion,
wherein the third ring portion is disposed on the second ring portion, and
wherein the third ring portion comprises an axially split ring or a radially split ring.

2. The bearing ring according to claim 1,
wherein the first ring portion is formed from a first material, the second ring portion is formed from a second material and the third ring portion is formed from a third material, and
wherein the second material is different than the first material and different than the third material.

3. The bearing ring according to claim 2,
wherein the first material and the third material are different.

4. The bearing ring according to claim 2,
wherein the second material is an electrical insulator.

5. The bearing ring according to claim 2,
wherein the second material has a density less than a density of the first material and less than a density of the third material.

6. The bearing ring according to claim 2,
wherein the second material is a vibration damping material.

7. The bearing ring according to claim 2,
wherein the second material is selected from the group consisting of: a polymer, a thermoset, a thermoplastic, a plastics composite, a ceramic plastic, and a metal.

8. The bearing ring according to claim 2,
wherein the second material is fiber-reinforced and/or comprises filler materials.

9. The bearing ring according to claim 2,
wherein a surface of the first layer in contact with the second layer is structured and/or wherein a surface of the third layer in contact with the second layer is structured.

10. The bearing ring according to claim 1,
wherein the first ring portion is located inside the second ring portion, and
wherein a maximum outer diameter of the second ring portion is greater than a minimum inner diameter of the third ring portion.

11. The bearing ring according to claim 1,
wherein the second ring portion is located inside the first ring portion, and
wherein a minimum inner diameter of the second ring portion is less than a maximum outer diameter of the third ring portion.

12. The bearing ring according to claim 1,
wherein the first ring portion is located inside the second ring portion,
wherein the first ring portion is formed from a first material, the second ring portion is formed from a second material and the third ring portion is formed from a third material,
wherein the second material is different than the first material and different from the third material,
wherein a radially outer surface of the first ring portion is convex and a radially inner surface of the first ring portion is concave,
wherein the first ring portion includes a first annular side wall axially spaced from a second annular side wall, and
wherein the second ring portion is disposed on the radially outer surface and on the first and second annular side walls.

13. The bearing ring according to claim 12,
wherein a radially outer surface of the second ring portion includes:
a cylindrical central portion,
a first beveled portion at a first axial side of the central portion, and
a second beveled portion at a second axial side of the central portion.

14. The bearing ring according to claim 12,
wherein the radially outer surface of the second ring portion further includes
a first cylindrical surface at a first axial end of the first beveled portion, and
a second cylindrical surface at a second axial end of the second beveled portion.

15. The bearing ring according to claim 14,
wherein a maximum axial width of the second ring portion is greater than a maximum axial width of the first ring portion.

16. The bearing ring according to claim 1,
wherein a maximum axial width of the second ring portion is greater than a maximum axial width of the first ring portion.
